(19) United States
(12) Patent Application Publication
(10) Pub. No.: US 2024/0358564 A1
(43) Pub. Date: Oct. 31, 2024

(54) LIFT SYSTEM

(71) Applicant: AUSTIN HARDWARE & SUPPLY, INC., LEE'S SUMMIT, MO (US)

(72) Inventors: Mark Jeffries, Buford, GA (US); Robert Walden, Buford, GA (US)

(21) Appl. No.: 18/646,255

(22) Filed: Apr. 25, 2024

Related U.S. Application Data
(60) Provisional application No. 63/462,126, filed on Apr. 26, 2023.

(51) Int. Cl. A61G 3/00; B66F 11/00

(52) U.S. Cl. CPC A61G 3/001; B66F 11/00

(57) ABSTRACT

A lift system for an oxygen bottle is described. The lift system includes a frame. The lift system includes a counterbalance assembly and a cradle assembly. The cradle assembly hold the oxygen bottle or other article. The counterbalance assembly includes several biasing devices to adjust a counterbalance force provided by the counterbalance assembly to accommodate oxygen bottles with different weights. The lift system may be employed on ambulances or other emergency vehicles.

The present application claims priority to U.S. Provisional Patent Application No. 63/462,126 filed Apr. 26, 2023, which is incorporated by reference.

### FIELD OF INVENTION

The present invention relates to a lift system.

### BACKGROUND OF INVENTION

Ambulance and emergency vehicle personnel typically manually load and unload oxygen bottles into their respective ambulance or emergency vehicle. The oxygen bottles may weigh 50 to 150 pounds or more, and work-place injuries are common when loading and unloading the oxygen bottles.

### SUMMARY OF INVENTION

A lift system for an oxygen bottle is described. The lift system includes a frame. The lift system includes a counterbalance assembly. The counterbalance assembly is configured to move relative to the frame. The counterbalance assembly includes a first biasing device and second biasing device. The first biasing device and the second biasing device counterbalance a weight of the oxygen bottle to ease the raising and lower of the oxygen bottle. The first biasing device is configured to selectively connect and disconnect from the frame. The second biasing device is configured to selectively connect and disconnect from the frame. A cradle assembly is configured to support the oxygen bottle, and the cradle assembly is affixed to the counterbalance assembly. The user may connect and disconnect the first biasing device and/or the second biasing device to adjust a counterbalance force provided by the counterbalance assembly. The lift system uses the biasing devices to assist in raising and lowering the cradle assembly and the oxygen bottle. This helps to reduce the manual lifting of the heavy oxygen bottles.

In one aspect, a lift system for an oxygen bottle is described. The lift system includes a frame. The lift system includes a counterbalance assembly and a cradle assembly. The counterbalance assembly is configured to move relative to the frame. The counterbalance assembly includes a first gas spring, a second gas spring, and a third gas spring. Cables from the first gas spring, the second gas spring, and the third gas spring are configured to connect and disconnect from the frame in order to activate or deactivate any of the first gas spring, the second gas spring, and the third gas spring in order to adjust a counterbalance force provided by the counterbalance assembly. One, two, or all three of the first gas spring, the second gas spring, and the third gas spring may be activated. When all three of the first gas spring, the second gas spring, and the third gas spring are activated, the lift system provides the most counterbalance force. Thus, the user may adjust the amount of counterbalance force to accommodate different weights of oxygen bottles. The lift system may also be used raise and lower other gas bottles and other articles. The lift system may be installed on an interior surface of a door of a cabinet on an ambulance.

In one aspect, a lift system for an oxygen bottle is described. The lift system includes a frame. The lift system includes a counterbalance assembly configured to move relative to the frame. The counterbalance assembly includes a first biasing device and second biasing device. The first biasing device is configured to selectively connect and disconnect from the frame. The second biasing device is configured to selectively connect and disconnect from the frame. A cradle assembly is configured to support the oxygen bottle. The cradle assembly is affixed to the counterbalance assembly. The first biasing device and second biasing device may include gas springs or other mechanical springs.

In one aspect, a lift system for an oxygen bottle is described. The lift system includes a frame. The lift system includes a counterbalance assembly configured to move relative to the frame. The counterbalance assembly includes a first biasing device, a second biasing device, and a third biasing device. The first biasing device is configured to selectively connect and disconnect from the frame. The second biasing device is connected to the frame and provides a minimum or baseline biasing force for the system. The third biasing device is configured to selectively connect and disconnect from the frame. A cradle assembly is configured to support the oxygen bottle. The cradle assembly is affixed to the counterbalance assembly. The first biasing device, the second biasing device, and the third biasing device may include gas springs, mechanical springs, or combinations thereof. The user may connect and disconnect the first and third biasing devices to add biasing force to the minimum or baseline biasing force provided by the second biasing device.

In one aspect, a lift system for an oxygen bottle is described. The lift system includes a frame. The lift system includes a counterbalance assembly configured to move relative to the frame. A cradle assembly is configured to support an oxygen bottle. The cradle assembly is affixed to the counterbalance assembly. The counterbalance assembly includes a gas spring with a rod that extends and retracts from the gas spring. A first end of a cable is engaged to an end of the rod. A second end of the cable is engaged to a carrier. The carrier is configured to engage and disengage with an attachment plate. The attachment plate is affixed to the frame.

In one aspect, a lift system for an oxygen bottle is described. The lift system includes a frame. The lift system includes a counterbalance assembly configured to move relative to the frame. A cradle assembly is configured to support an oxygen bottle. The cradle assembly is affixed to the counterbalance assembly. The counterbalance assembly includes a first gas spring with a first rod that extends and retracts from the first gas spring. A first end of a first cable is engaged to an end of the first rod. A second end of the first cable is engaged to a first carrier. The first carrier is configured to engage and disengage with an attachment plate. The counterbalance assembly includes a second gas spring with a second rod that extends and retracts from the second gas spring. A first end of a second cable is engaged to an end of the second rod. A second end of the second cable is engaged to a second carrier. The second carrier is engaged to the attachment plate. The counterbalance assembly includes a third gas spring with a third rod that extends and retracts from the third gas spring. A first end of a third cable is engaged to an end of the third rod. A second end of the third cable is engaged to a third carrier. The third carrier is configured to engage and disengage with the attachment plate.

In one aspect, a counter-balance system for raising and lowering a gas cylinder is described. The system includes a frame. The system includes a counterbalance assembly. The counterbalance assembly is configured to move relative to the frame. The counterbalance assembly includes a first biasing device and a second biasing device. The first biasing device is configured to connect and disconnect from the frame. The second biasing device is configured to connect and disconnect from the frame. A cradle assembly is configured to support the gas cylinder. The cradle assembly is affixed to the counterbalance assembly.

In one aspect, a vehicular lift system to lift and lower an article is described. The system includes a frame configured to engage to a vehicle. The system includes a counterbalance assembly. The counterbalance assembly is configured to move relative to the frame. The counterbalance assembly includes a first biasing device and second biasing device. The first biasing device is configured to connect and disconnect from the frame. The second biasing device is configured to connect and disconnect from the frame. A cradle assembly is configured to support the article, and the cradle assembly affixed to the counterbalance assembly.

### BRIEF DESCRIPTION OF DRAWINGS

FIG. 1 are views of the lift system installed on the door of the cabinet.

FIG. 2 are views of the lift system installed on the door of the cabinet.

FIG. 3 are views of the lift system installed on the door of the cabinet.

FIG. 4 are views of the lift system installed on a door of a cabinet with the cradle lowered.

FIG. 5 are views of the frame and counterbalance assembly.

FIG. 6 are views of the frame and counterbalance assembly.

FIG. 7 are views of the frame and counterbalance assembly.

FIG. 8 are views of the frame.

FIG. 9 are views of the frame.

FIG. 10 are views of the counterbalance assembly.

FIG. 11 are views of the counterbalance assembly.

FIG. 12 are views of the counterbalance assembly.

FIG. 13 are views of the gas springs.

FIG. 14 are views of the housings for the gas springs.

FIG. 15 are views of the cradle assembly.

FIG. 16 are views of the cradle assembly.

FIG. 17 are views of the cradle assembly.

FIG. 18 are views of the adjustment for bottle diameter.

FIG. 19 are views of the handle.

FIG. 20 is an exploded view of the handle.

FIG. 21A are views of the handle.

FIG. 21B are views of the handle.

FIG. 22A are views of the rotary latch.

FIG. 22B are views of the rotary latch.

FIG. 23 are views of the rotary latch.

FIG. 24 are views of the rotary latch.

FIG. 25 is a view of the counterbalance assembly.

### DETAILED DESCRIPTION

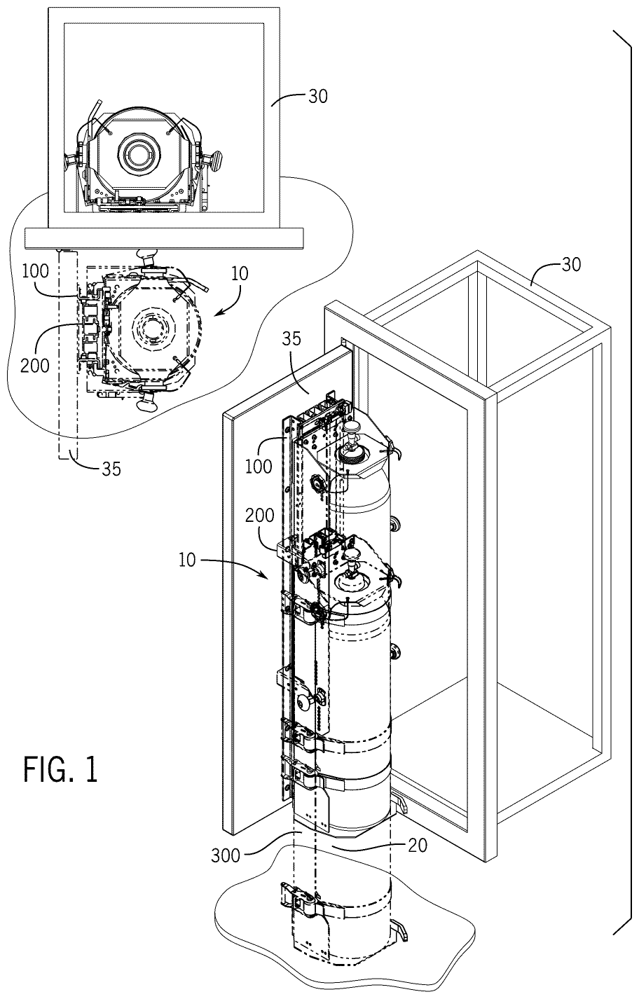

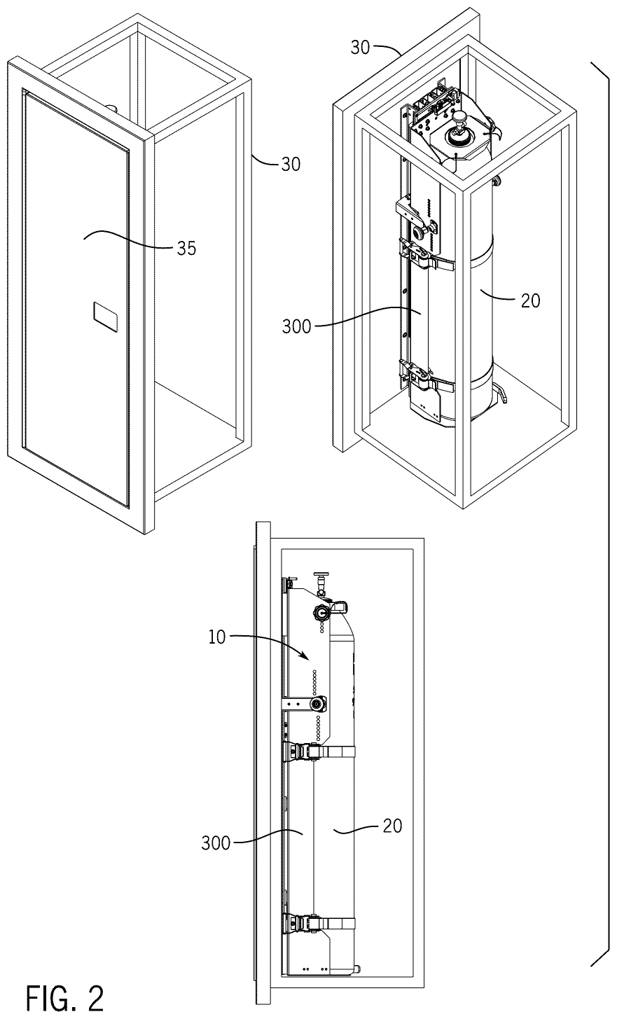

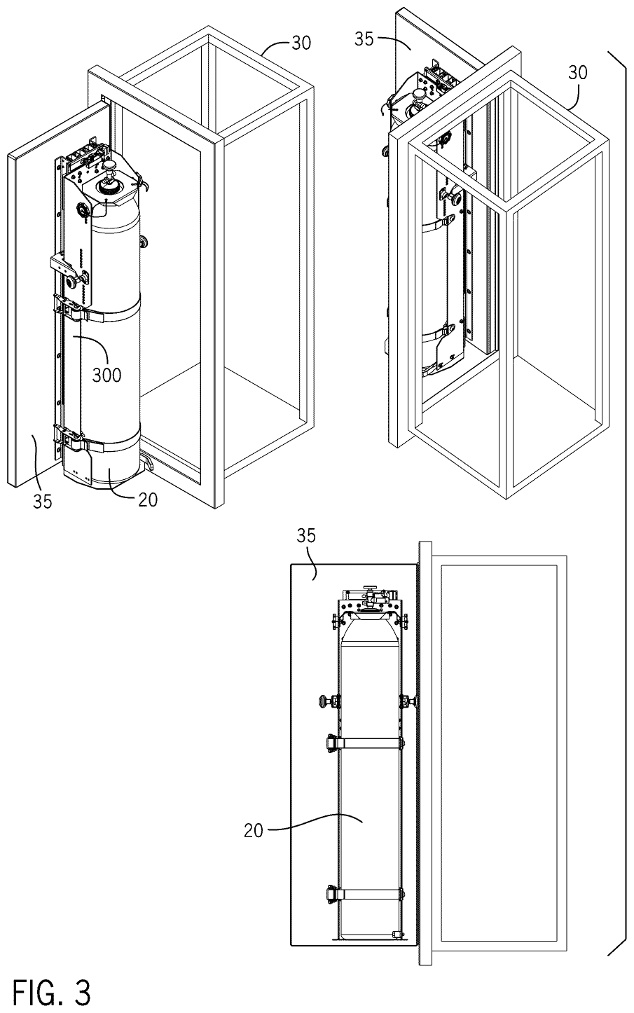

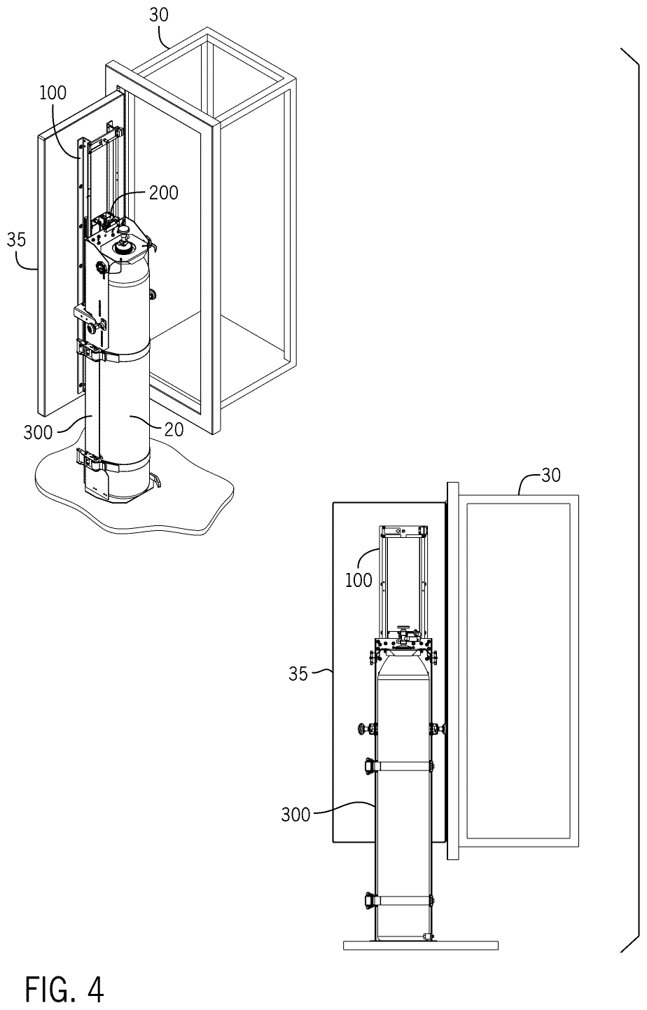

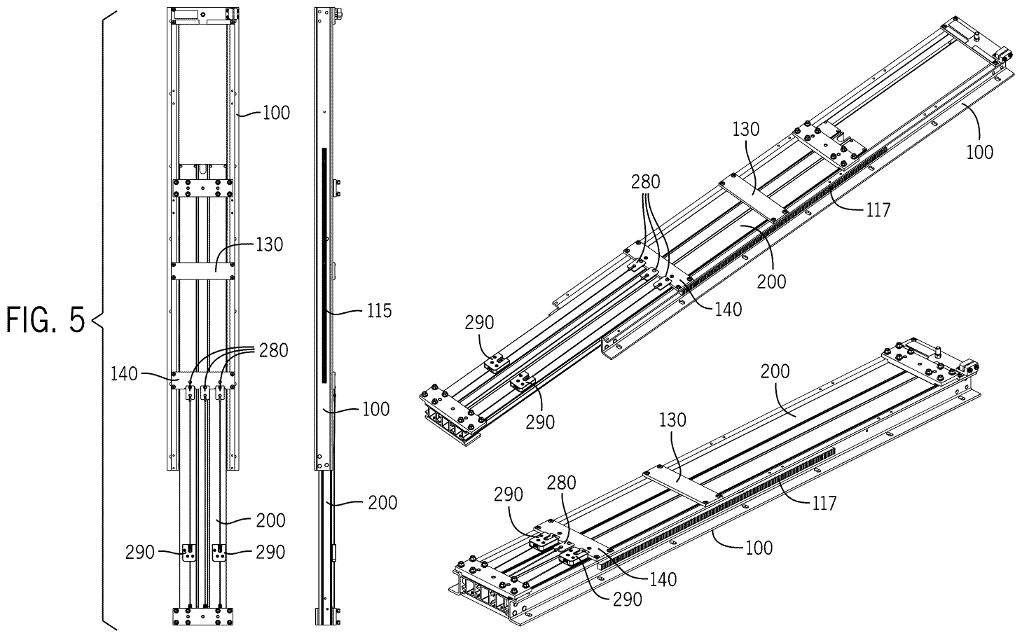

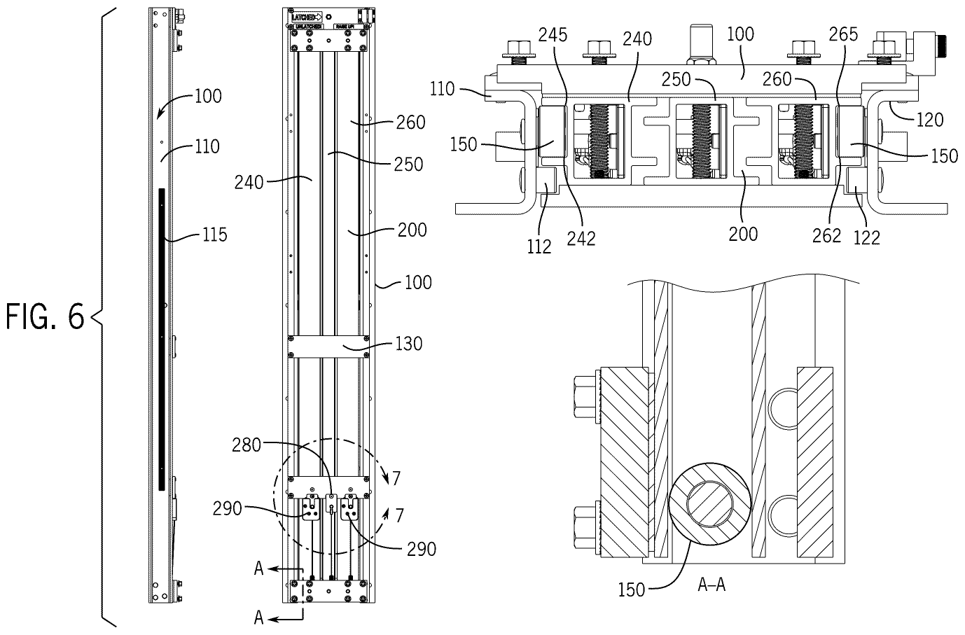

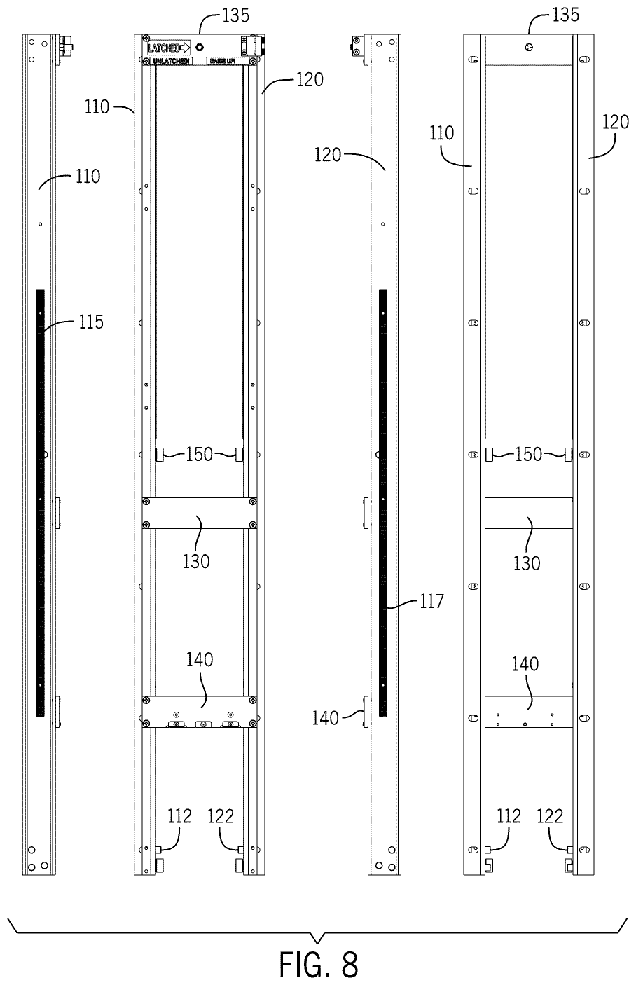

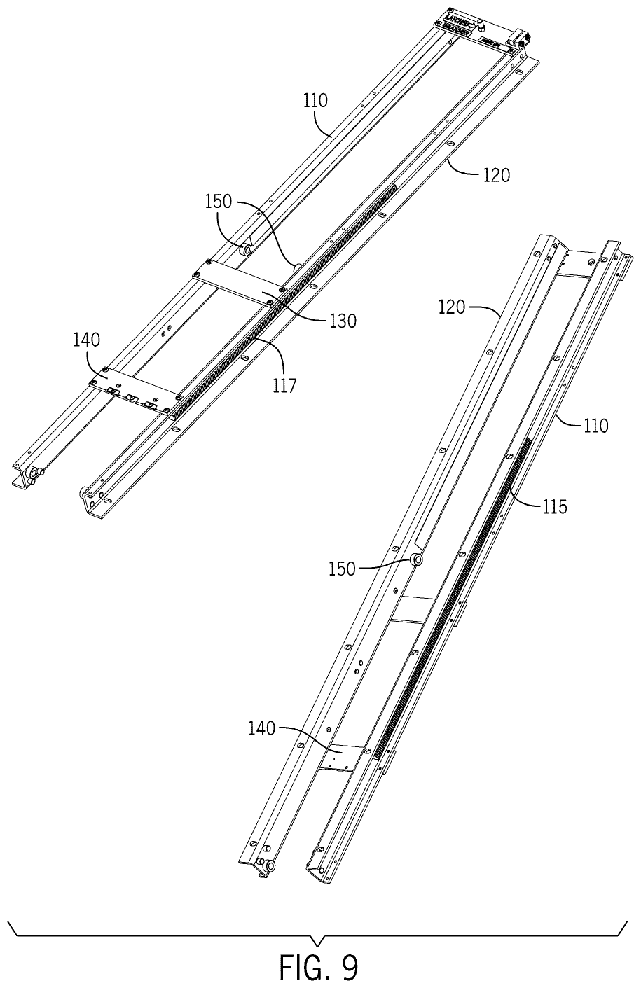

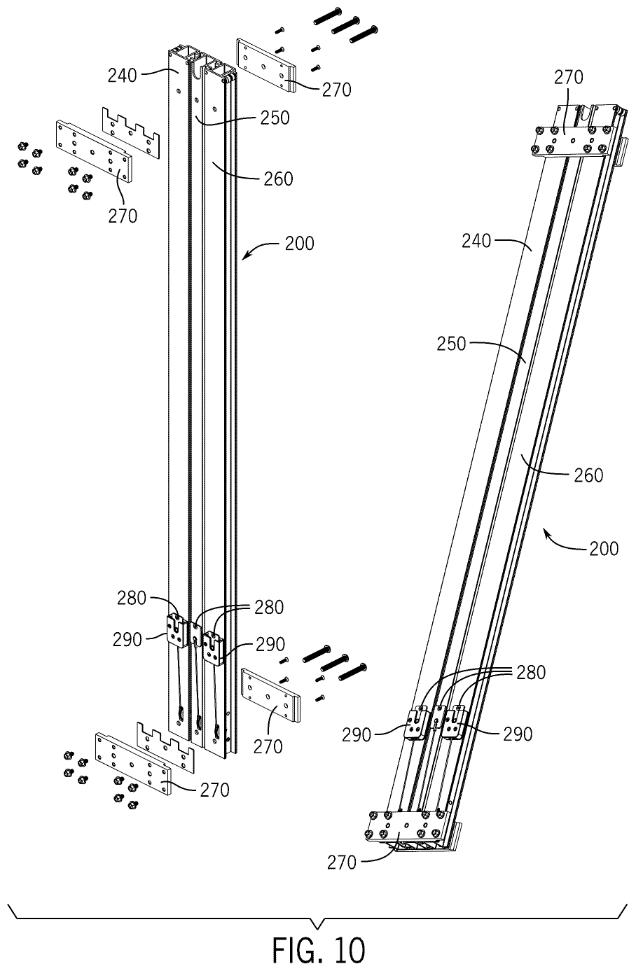

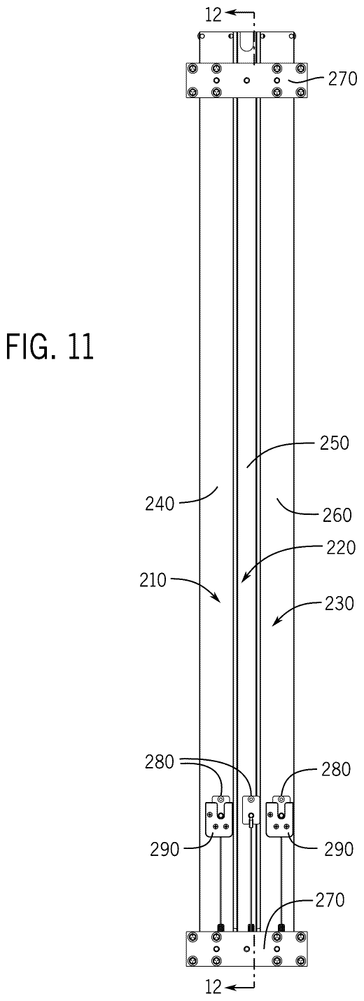

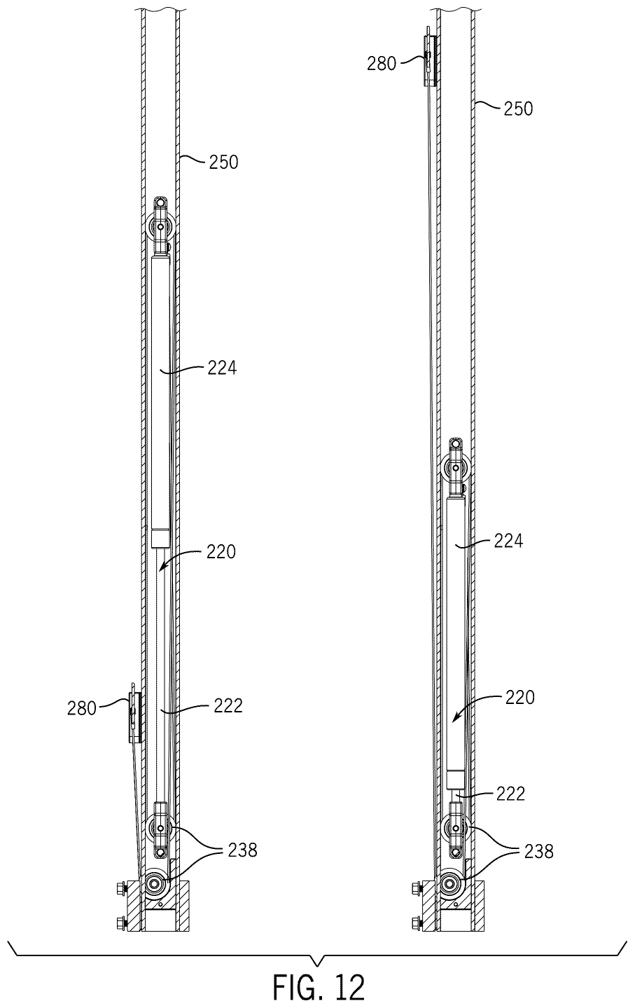

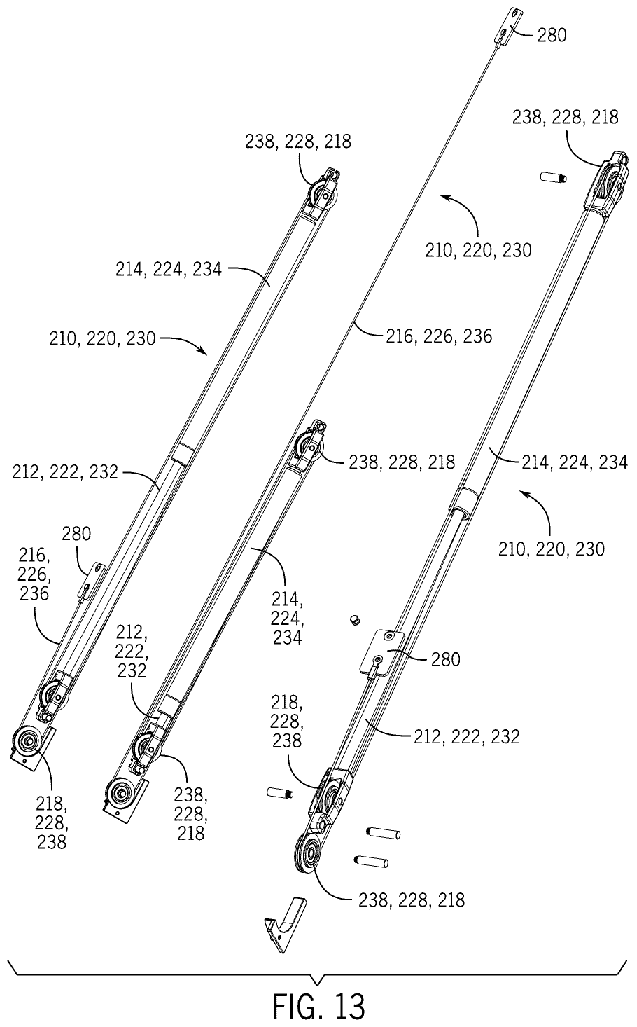

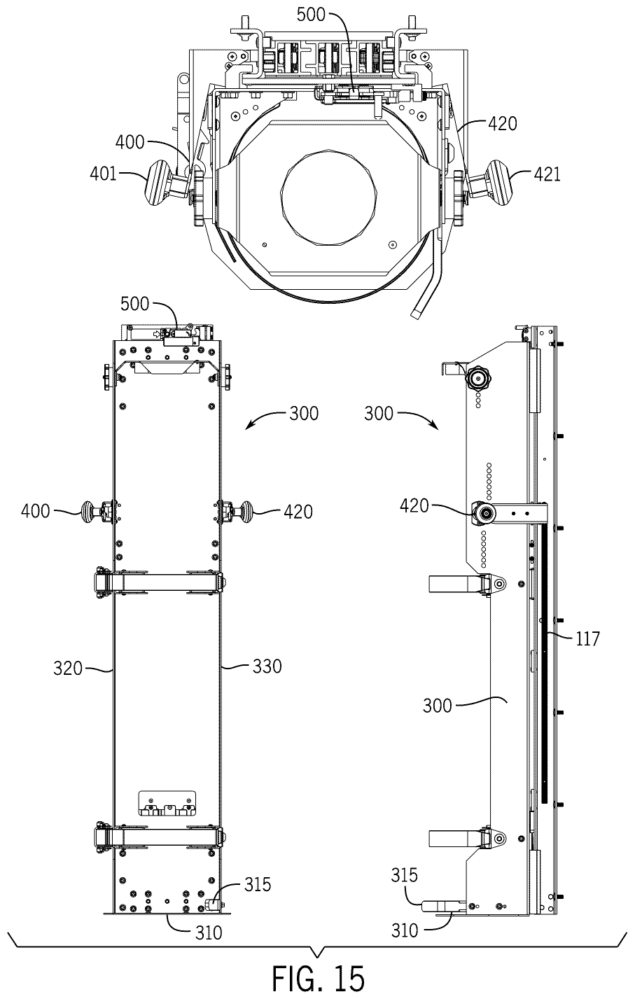

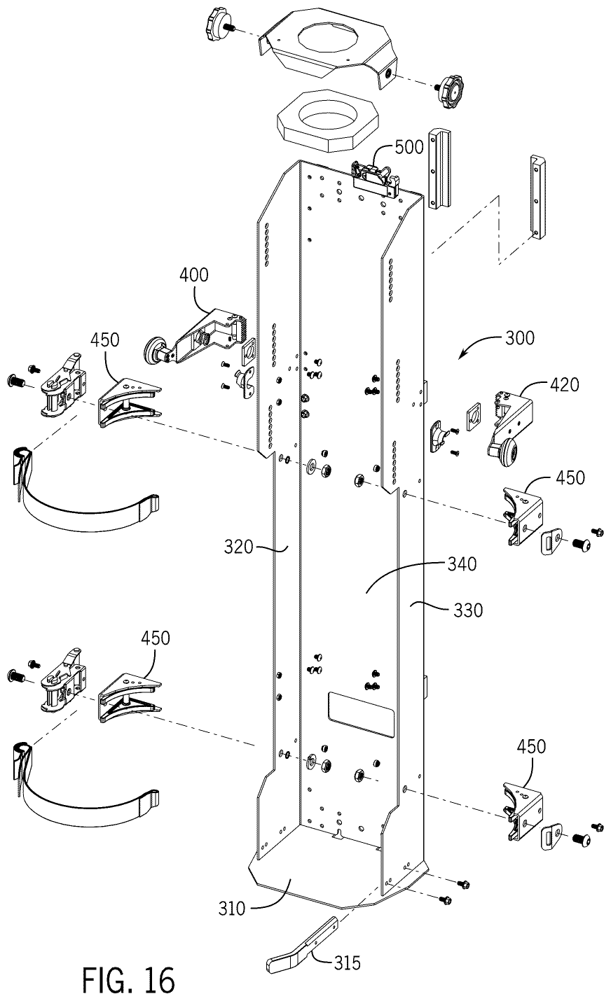

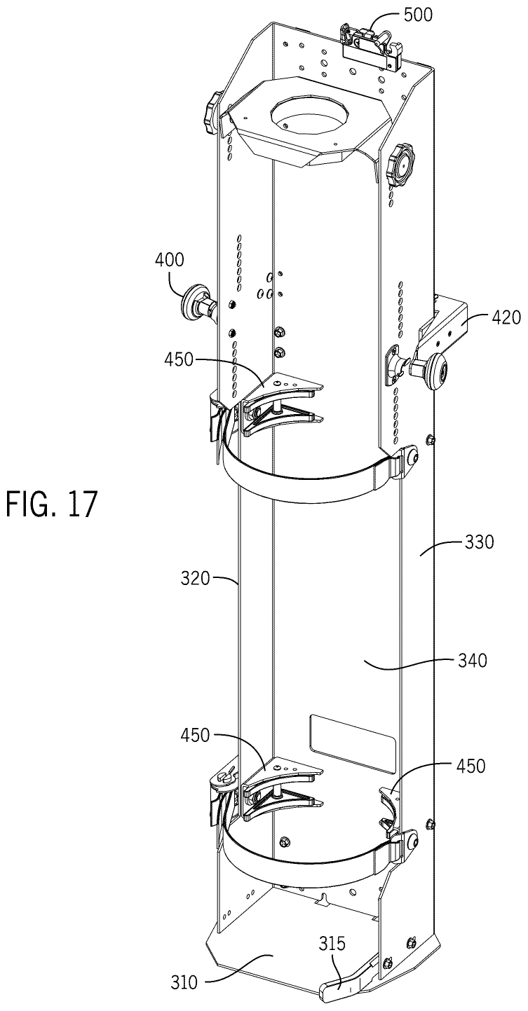

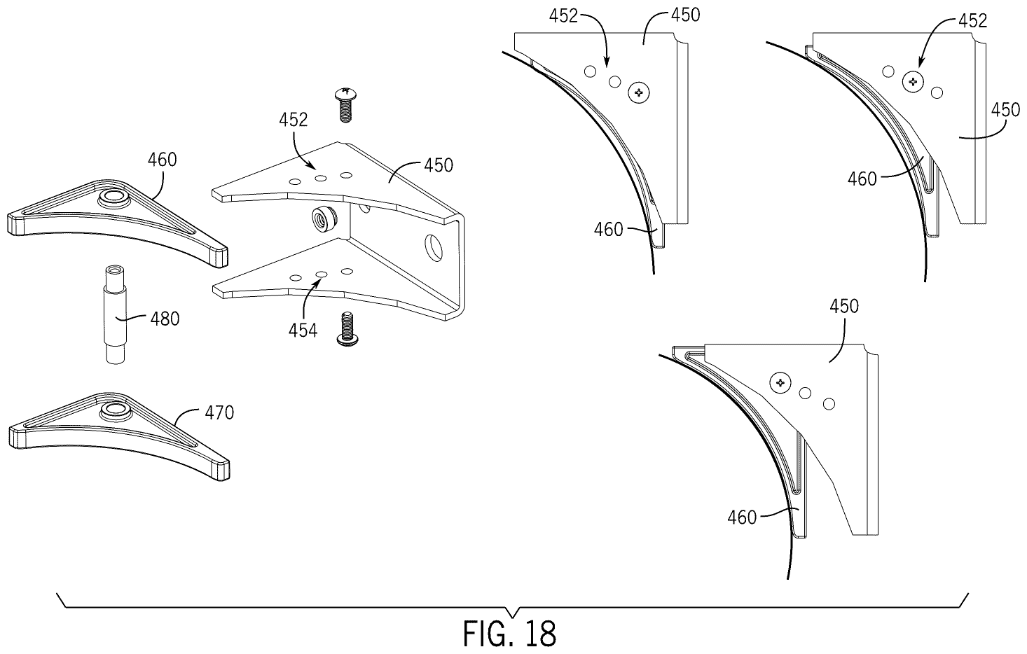

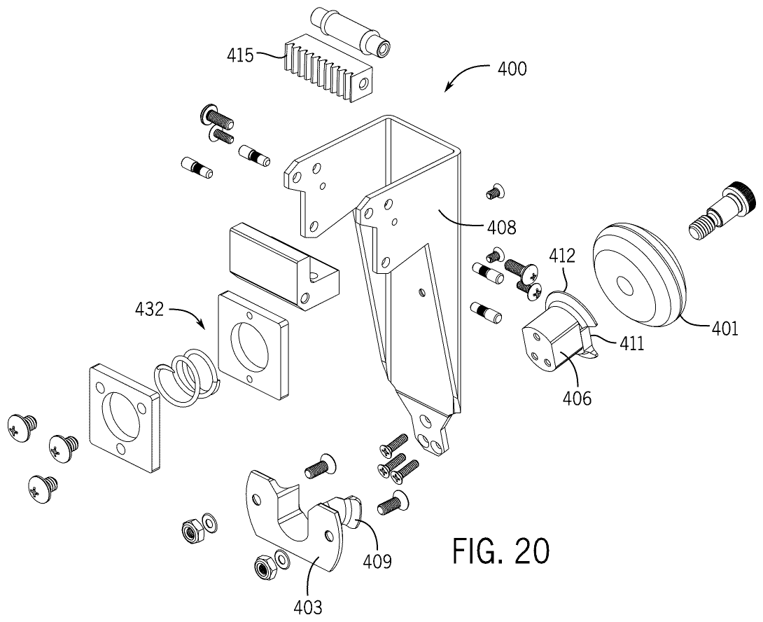

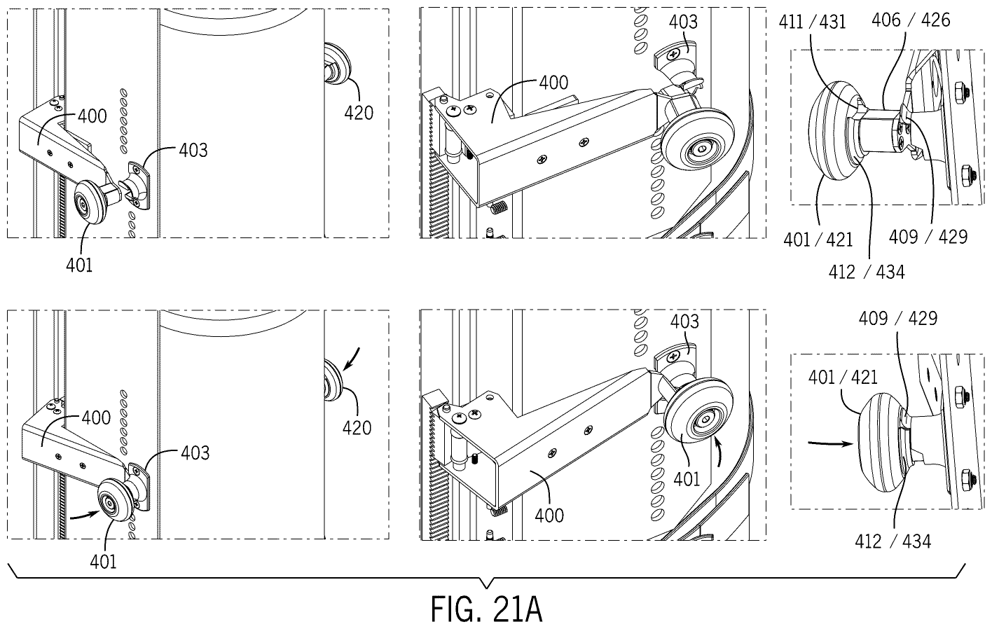

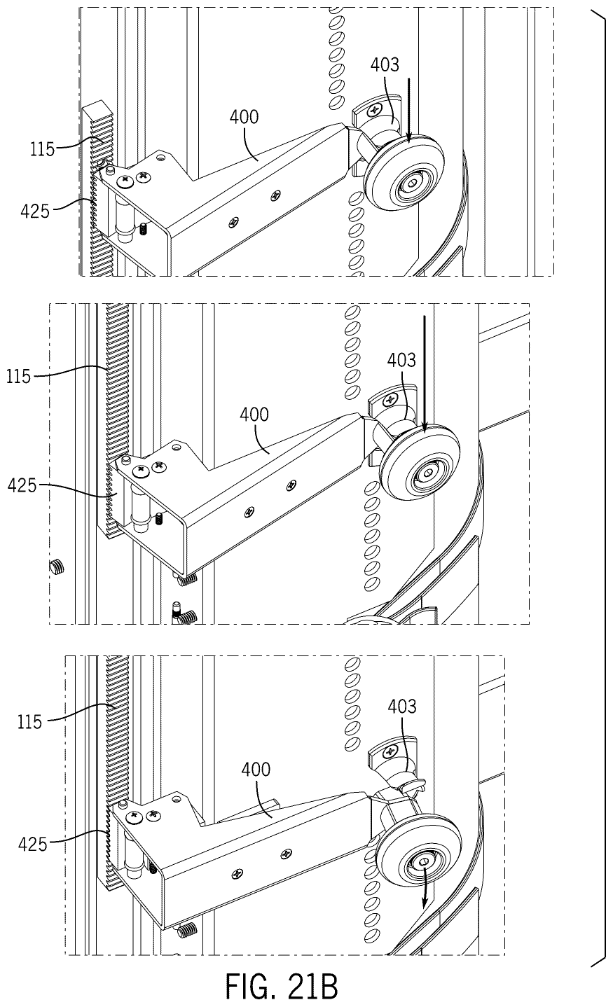

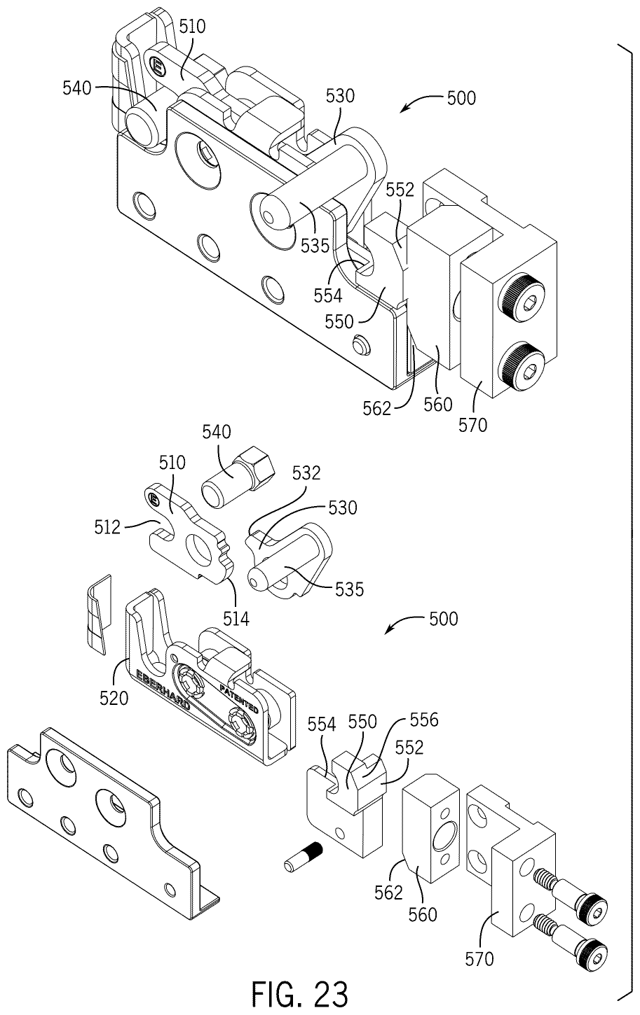

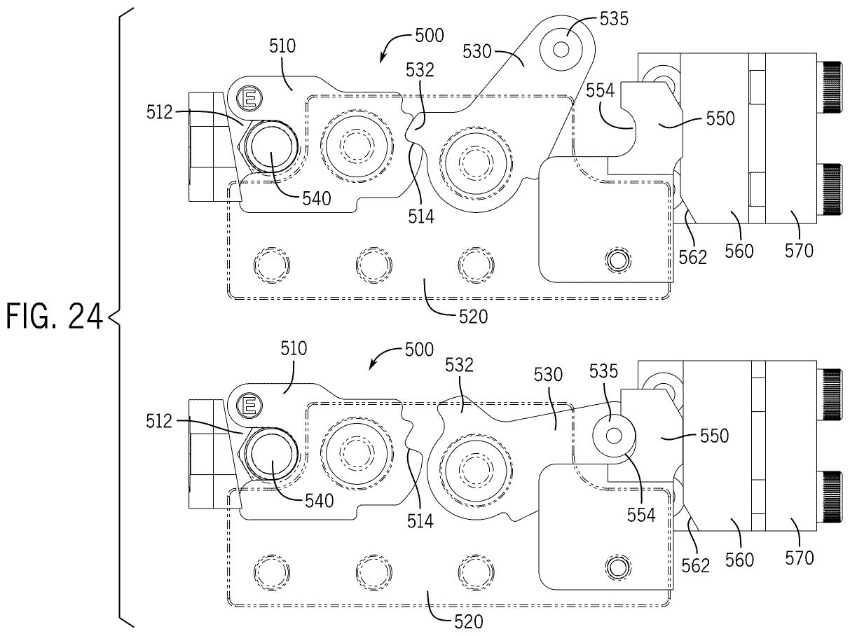

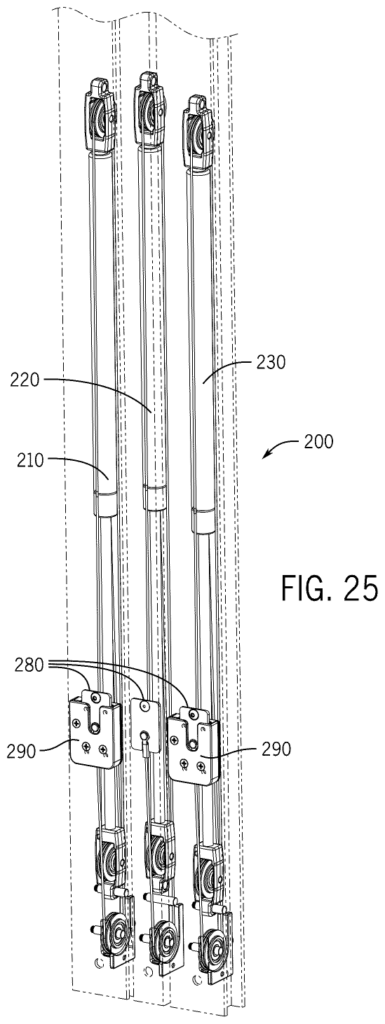

A lift system 10 will now be described with reference to FIGS. 1-25. A lift system 10 comprises a frame 100, a counterbalance assembly 200, and a cradle assembly 300. The lift system 10 may be used to lift, hold, and/or lower an oxygen bottle 20 or other items. The lift system 10 provides a counterbalance force that makes raising and lowering the oxygen bottle 20 easier and safer for the user. The lift system 10 may easily adjusted by the user to accommodate different sizes or weights of oxygen bottles 20.

The frame 100 is shown secured to a door 35 of a cabinet 30. The cabinet 30 may be located on an ambulance, fire truck, other emergency vehicle. The cabinet 30 may also be employed on other work or commercial vehicles. In other aspects and applications, the frame 100 may be installed on a variety of surfaces and structures, such as, a wall or side of an emergency vehicle or a work truck. The frame 100 may also be used in non-moving structures, such as buildings, garages, etc.

The counterbalance assembly 200 slides or moves relative to the frame 100. The counterbalance assembly 200 supports the cradle assembly 300. The cradle assembly 300 holds the oxygen bottle 20 or other items. The lift system 10 utilizes multiple block and tackle assemblies with easy conversion or adjustment of total counterbalancing force by activating or de-activating individual biasing devices or counterbalance modules. The cradle assembly 300 is biased upward by the counterbalance assembly 200, which makes lifting the oxygen bottles 20 easier for the user.

The frame 100 includes a first vertical member 110 and a second vertical member 120. The first vertical member 110 and the second vertical member 120 are joined by reinforcement plates 130 and 135. The first vertical member 110 and the second vertical member 120 are further joined by an adjustment plate 140. The adjustment plate 140 is fixed to the frame 100. In this aspect, inner surfaces of the first vertical member 110 and the second vertical member 120 include rollers 150. In operation, the counterbalance assembly 200 moves up and down between the first vertical member 110 and the second vertical member 120. The counterbalance assembly 200 may roll against both the first vertical member 110 and the second vertical member 120.

In this aspect, the counterbalance assembly 200 includes a first biasing device 210, a second biasing device 220, and a third biasing device 230. The lift system 10 is adjusted to accommodate different weights of bottles. The lift system 10 may be adjusted by activating and/or deactivating one or more of the biasing devices 210, 220, and 230. In other aspects, less than three biasing devices may be utilized.

The first biasing device 210 is mounted to a first housing 240. The second biasing device 220 is mounted to a second housing 250. The third biasing device 230 is mounted to a third housing 260. The housings 240, 250, and 260 are secured together via attachment plates 270. The housings 240, 250, and 260 are arranged in a parallel fashion. The housings 240, 250, and 260 are arranged in a vertical orientation.

In this aspect, the lift system 10 includes three biasing devices and three housings to hold the biasing devices. In other aspects, the lift system 10 may include two, four, or five or more biasing devices. Depending upon the weight of the oxygen bottle 20 or other product, any number of the biasing devices may be deactivated. For example, a smaller oxygen bottle 20 may only require that one of the biasing devices 210, 220, and 230 is used to provide acceptable counterbalance force. A medium sized oxygen bottle 20 may only require that two of the biasing devices 210, 220, and 230 are used to provide an acceptable counterbalance force. A large sized oxygen bottle 20 may require that all three of the biasing devices 210, 220, and 230 are used to provide acceptable counterbalance force. Thus, the user may adjust the amount of counterbalance force provided by the lift system 10 by activating or deactivating one or more of the biasing devices 210, 220, and 230.

In this aspect, the biasing devices 210, 220, and 230 include gas springs. The biasing devices 210, 220, and 230 includes rods 212, 222, and 232 that extend from cylinder portions 214, 224, and 234. Cables 216, 226, and 236 attach to the rods 212, 222, and 232. The cables 216, 226, and 236 are directed through a series of pulleys 218, 228, 238 that increase the mechanical advantage of the block and tackle design. In this aspect, a length of the extension and retraction of the rods 212, 222, and 232, via the pulleys 218, 228, 238, is approximately tripled such that the movement of the cables 216, 226, and 236 is approximately triple the length of the extension and retraction of the rods 212, 222, and 232. In other aspects, the movement may be lengthened or shortened.

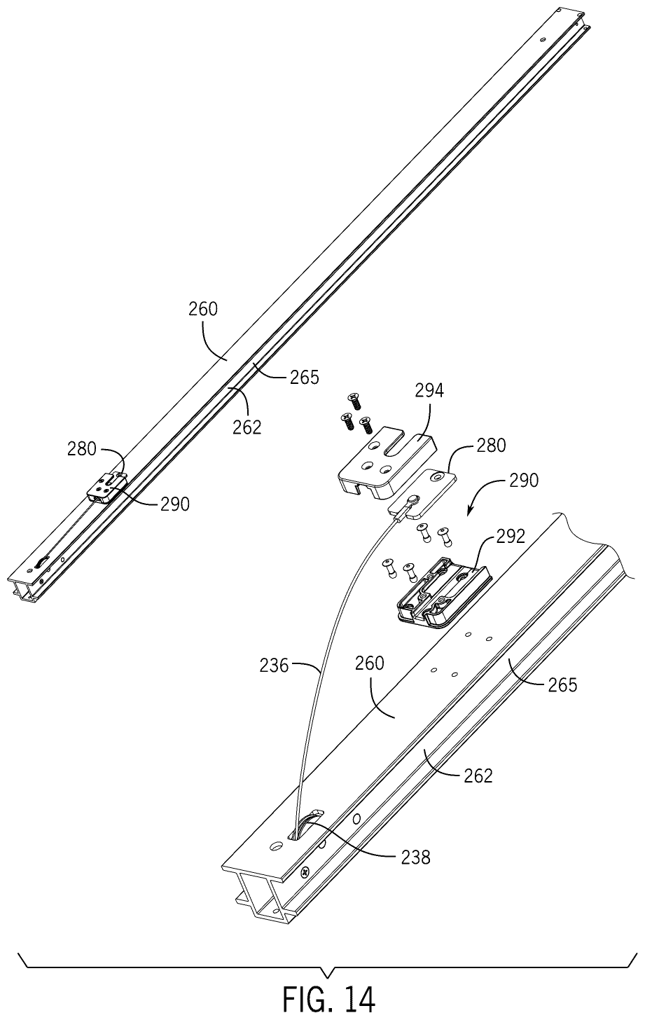

A first end of the cables 216, 226, and 236 is engaged to an end of the rods 212, 222, and 232. A second end of the cables 216, 226, and 236 are engaged to carriers 280. The carriers 280 are configured to engage and disengage with the adjustment plate 140. For example, the carriers 280 may be attached or fastened and detached or unfastened to the adjustment plate 140 by a screw or other fastener. Corresponding holes in the carrier 280 and the adjustment plate 140 receive screws to fix the carrier 280 to the adjustment plate 140, which is fixed to the frame 100. In this aspect, the carriers 280 for the biasing devices 210 and 230 are configured to be selectively held by a stop assembly 290. With reference to FIG. 14, the stop assembly 290 comprises a bottom piece 292 and a top cover 294. In this aspect, the stop assemblies 290 are attached to the respective housing 240 and 260, and the stop assemblies 290 are generally fixed in position relative the respective housing 240 and 260. In other aspects, the housing 250 may also include the stop assembly 290.

The stop assemblies 290 are configured to removably receive the carrier 280. The individual carrier 280 seats between the bottom piece 292 and the top cover 294. The cables 216, 226, 236 are pre-loaded and pull against a back edge of a pocket in bottom piece 292 of the stop assembly 290.

The carriers 280 are configured to selectively connect and disconnect from the adjustment plate 140 of the frame 100. This provides for the selective disconnection of the biasing devices 210, 220, and 230 as needed by the user.

When the carrier 280 is engaged or fixed to the adjustment plate 140, then the particular biasing device is now active, i.e., the particular biasing device is counterbalancing the cradle assembly 300. The adjustment plate 140 is generally fixed in position relative to the frame 100, and the counterbalance assembly 200 and the cradle assembly 300 move relative to the frame 100. When the carrier 280 is not engaged or not fixed to the adjustment plate 140, then the particular biasing device is passive and is not impacting the movement of the counterbalance assembly 200 and the cradle assembly 300. When the particular biasing device is passive, the carrier 280 is held in the stop assembly 290 and moves with the cradle assembly 300 and the counterbalance assembly 200. When the particular biasing device is active, the carrier 280 is fixed to the frame 100 via the adjustment plate 140 and the user has to overcome the force of the biasing devices 210, 220, and/or 230 and pull the cables 216, 226, 236 out of the biasing devices 210, 220, and 230 in order move the counterbalance assembly 200. The user may activate and deactivate the biasing devices 210, 220, and 230 as needed for the current oxygen bottle 20 stored in the cradle assembly 300.

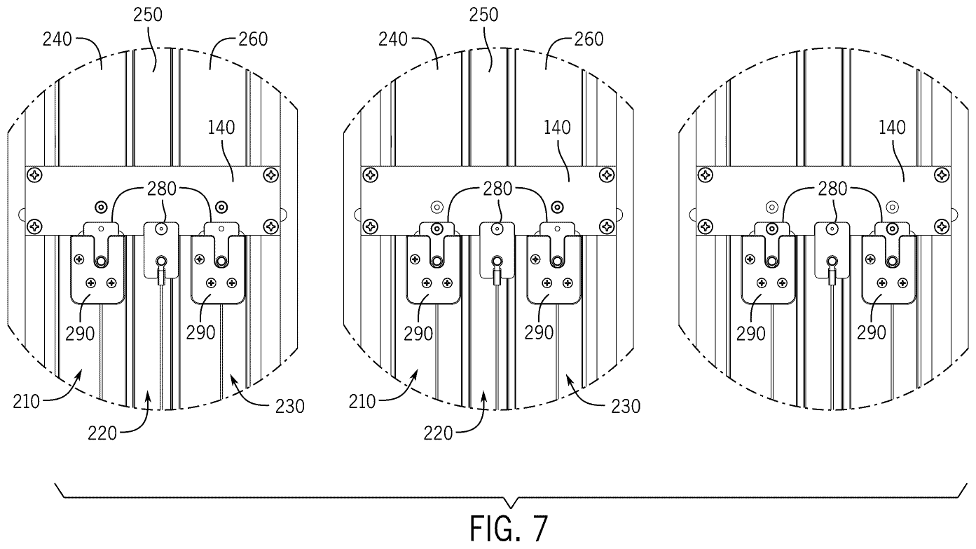

In this aspect, with respect to FIG. 7, the carrier 280 of the second biasing device 220 is shown as riveted to the adjustment plate 140, while the carriers 280 of the first biasing device 210 and the third biasing devices 230 are shown with screws. Thus, the second biasing device 220 provides a minimum counterbalance force and the first biasing device 210 and the third biasing devices 230 may be added by the user as needed to accommodate a heavier weight of the larger oxygen bottles 20. In the left view of FIG. 7, only the second biasing device 220 is active. In the middle view of FIG. 7, the first biasing device 210 is screwed to the adjustment plate 140, and thus the first biasing devices 210 and the second biasing devices 220 are active. In the right image of FIG. 7, the first biasing device 210 is screwed to the adjustment plate 140 and the third biasing device 210 is screwed to the adjustment plate 140, and thus all three biasing devices 210 are active. This shows show how to modulate or adjust the upward biasing force of the counterbalance assembly 200. The selective activation or deactivation or the selective connection and disconnection of the biasing devices 210, 220, and 230 provide adjustability for the lift system 10 to accommodate different weights of oxygen bottles 20 or other items of different weight.

In this aspect, exterior surfaces 242 and 262 of the housings 240 and 260 form or define a track or race to receive the rollers 150. This provides for the counterbalance assembly 200 to roll against the frame 100. The tracks or races are positioned on lateral sides of the counterbalance assembly 200. In other aspects, wheels, bearings, glide surfaces, etc. may be utilized to provide a sliding or moveable engagement between the counterbalance assembly 200 and the frame.

In this aspect, the exterior surface 242 of the housing 240 defines a track 245. Similarly, the exterior surface 262 of the housing 260 defines a track 265. The tracks 245 and 265 are positioned on outer lateral sides of the counterbalance assembly 200. The tracks 245 and 265 receive the roller 150 in a moving engagement.

The biasing devices 210, 220, 230 may include gas springs, compression springs, extension springs, and other mechanical biasing devices. In other aspects, the counterbalance assembly 200 may employ a combination of the different types of biasing devices. For example, a mechanical spring may provide baseline amount of bias and one or more selectively activatable gas springs may provide additional bias.

The cradle assembly 300 is affixed to the counterbalance assembly 200. The cradle assembly 300 may attach to the attachment plates 270 of the counterbalance assembly 200. The cradle assembly 300 includes a horizontal support structure 310, a first sidewall 320, a second sidewall 330, and a back wall 340. The back wall 340 of the cradle assembly 300 may be flush against front exteriors of the housings 240, 250, and 260. The cradle assembly 300 is configured to hold the oxygen bottle 20. Straps may secure the oxygen bottle 20 to the cradle assembly 300. The oxygen bottle 20 is placed on the horizontal support structure 310 and secured to the cradle assembly 300. The horizontal support structure 310 may include a foot grab 315 to assist the user in lowering the cradle assembly 300.

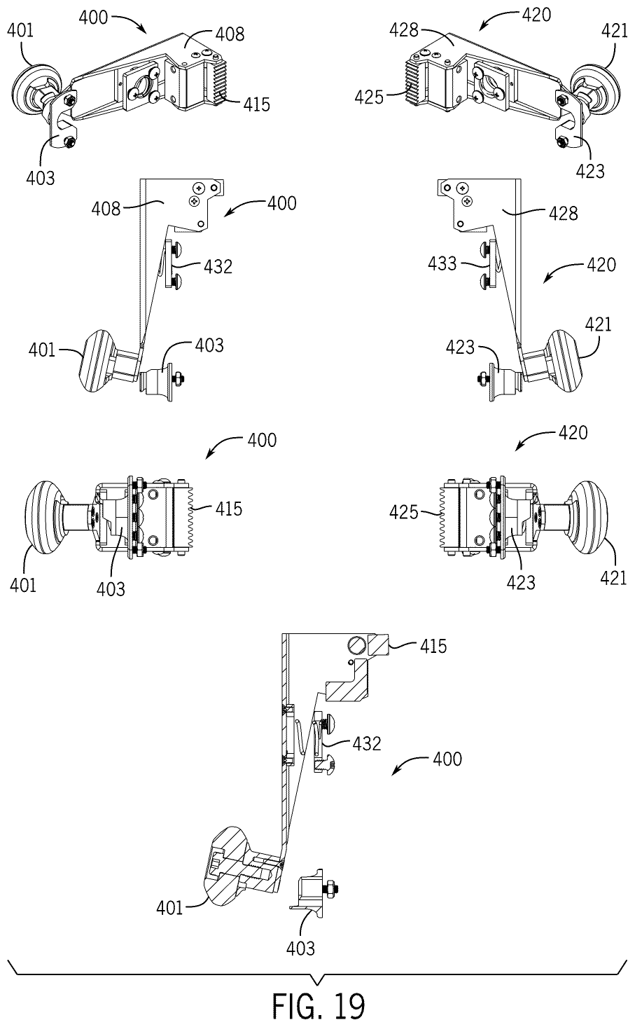

A first handle 400 and a second handle 420 will now be described with reference to FIGS. 19-21. The first handle 400 and the second handle 420 are oppositely disposed on the cradle assembly 300. The first handle 400 and the second handle 420 are manually pushed in by the user to allow the cradle assembly 300 to move up and own with respect to the frame 100. In this aspect, when the user releases the first handle 400 and the second handle 420, the cradle assembly 300 locks in place relative to the frame 100. The first handle 400 include a first knob portion 401, and the second handle 420 includes a second knob portion 421. In this aspect, the first handle 400 and the second handle 420 are spring-loaded or spring biased towards a locking position.

The first handle 400 is pivotally engaged to the first sidewall 320. The first handle 400 is spring biased to drive a gear locking side 415 into a first gear rack 115 of the first vertical member 110. The first handle 400 is configured to move inward toward the fame 100 to disengage the gear locking side 415 from the gear rack 115 of the frame 100.

The second handle 420 is pivotally engaged to the second sidewall 330. The second handle 420 is spring biased to drive a gear locking side 425 into a second gear rack 117 of the second vertical member 120. The second handle 420 is configured to move inward toward the frame 100 to disengage the gear locking side 425 from the second gear rack 117 of the frame 100.

In order to lower the cradle assembly 300 from a stored position, the user must push or move both the first handle 400 and the second handle 420 inward, which pivots the gear locking side 415 away from the first gear rack 115 and the second gear locking side 425 away from the second gear rack 117. Thus, for the sake of safety, the user must generally use two hands in order to move the cradle assembly 300 from the stored position. Further, this arrangement of the first handle 400 and the second handle 420 integrates the unlocking and the moving of the cradle assembly 300 by allowing the user to disengage the locking feature and move the cradle assembly 300 up and down without having to remove their hands from the cradle assembly 300.

When the first handle 400 and the second handle 420 are pushed in by the user such that the cradle assembly 300 is in a moveable position, the first handle 400 abuts a first thumb lip 403 and the second handle 420 abuts a second thumb lip 423. The first thumb lip 403 and the second thumb lip 423 helps the user's thumbs to hold the first handle 400 and the second handle 420 inwards while raising and lowering the cradle assembly 300. In this aspect, the first handle 400 and the second handle 420 include flat upper profiles 406 and 426 that abut lower surfaces of the first thumb lip 403 and the second thumb lip 423. Rim portions 409 and 429 of the first thumb lip 403 and the second handle 420 fit into openings 411 and 431 in rim portions 412 and 434 of the first handle 400 and the second handle 420. These features provide an ergonomic structure for the user grasp in order to lift and lower the cradle assembly 300. The combination of the first handle 400 and the second handle 420 with the first thumb lip 403 and the second thumb lip 423 allow the user to grasp the handle knob portions of the first handle first handle 400 and second handle 420 and wrap their thumbs around the combined structure. Further, as soon as the user lets go of either the first handle 400 or the second handle 420, the first handle 400 or the second handle 420 will pivot and drive their respective gear locking side 415 or 425 into the first gear rack 115 or second gear rack 117, which will stop the movement of the cradle assembly 300. This provides the automatic locking of the cradle assembly 300 in any position at any time simply by releasing either of the first handle 400 or the second handle 420.

In this aspect, the first handle 400 and second handle 420 include a similar construction. With respect to FIG. 19, the first handle 400 and second handle 420 include a central mount plate 432, 433. The first handle 400 and the second handle 420 pivot or rotate relative to the central mount plates 432, 433. The gear locking sides 415, 425 and the knob portions 401, 421 are positioned on opposite sides of the central mount plates 432, 433. The first handle 400 and the second handle 420 may include an angled body 408, 428 as shown. In other aspects, the first handle 400 and the 420 may include a linear body.

In other aspects, only one of the first gear rack 115 or the second gear rack 117 may be utilized. In other aspects, the one of the first handle 400 and the second handle 420 may engage the first gear rack 115 or the second gear rack 117 and the other of the first handle 400 and the second handle 420 may include a safety or stop mechanism that stops travel or limits travel at various positions.

The cradle assembly 300 is further configured to accommodate bottles 20 with different diameters. For example, oxygen bottles 20 are typically commercially available in diameters of 7 inches, 8, inches, and 9 inches. Brackets 450 with moveable upper bottle supports 460 and moveable lower bottle supports 470 are provided to accommodate the different bottles 20. The moveable upper bottle support 460 and the moveable lower bottle support 470 affix to the brackets 450 in different locations to accommodate oxygen bottles 20 with different diameters. The brackets 450 includes an upper set of openings 452 and lower set of openings 454 generally opposite of each other. A first end of a shaft 480 fits into an opening of an upper bottle support 460 and second end of the shaft 480 fits into a corresponding opening of the lower bottle support 470. The first end of the shaft 480 is secured to one of the openings in the lower set of openings 454 and the second end of the shaft 480 is secured to one of the openings in the upper set of openings 452. By securing the shaft 480 to different openings in the upper set of openings 452 and the lower set of openings 454, the location of the moveable upper bottle support 460 and the moveable lower bottle support 470 may be changed or varied to accommodate oxygen bottle 20 with different diameters. The adjustment generally provide two contact points or surfaces for the oxygen bottle 20.

In the stowed position of the cradle assembly 300, the rods 212, 222, and 232 are extended from their respective gas spring. In operation, from the stowed position of the cradle assembly 300, the user compresses the first handle 400 and the second handle 420 to unlock the cradle assembly 300 from the frame 100. The cradle assembly 300 may be moved downward under the weight of the oxygen bottle 20 and applied force from the user. The gas springs of the biasing devices 210, 220, and 230 begin to compress-with the rods 212, 222, and 232 entering the cylinder portions 214, 224, and 234. This lowers the cradle assembly 300 in a controlled manner, as the gas springs compress to provide a counterbalance to the weight of the cradle assembly 300 and oxygen bottle 20. The counterbalance assembly 200 further helps to lift the cradle assembly 300, as the stored energy from the compressed energy in the gas spring assists in extending the rods 212, 222, and 232 and thus assist in lifting the cradle assembly 300.

The lift system 10 and the cradle assembly 300 may include one or more stops, catches, and latches to limit the travel of the cradle assembly 300. As described above, the first handle 400 and the second handle 420 engage the first gear rack 115 and the second gear rack 117 to stop travel or movement of the cradle assembly 300. For example, a lower travel limit and/or an upper travel limit may be installed on the cradle assembly 300 or frame 100 to restrict the vertical travel of the cradle assembly 300 with respect to the frame 100. Further, the lift system 10 and the cradle assembly 300 may include a number of stops, catches, latches or locks to hold the cradle assembly 300 stationary in the lift system 10. The stops, catches, latches or locks may further automatically engage the cradle assembly 300.

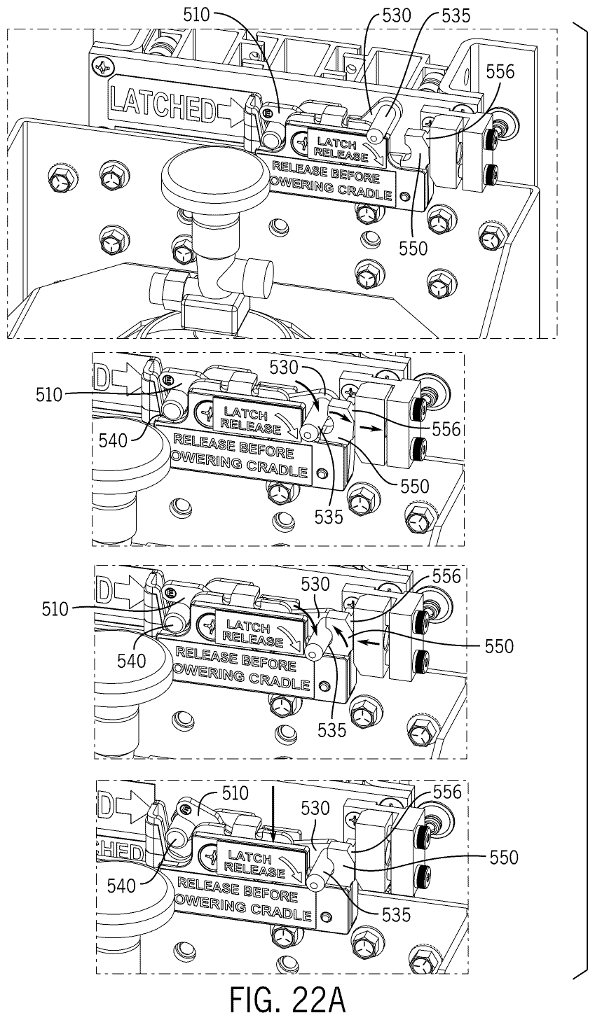

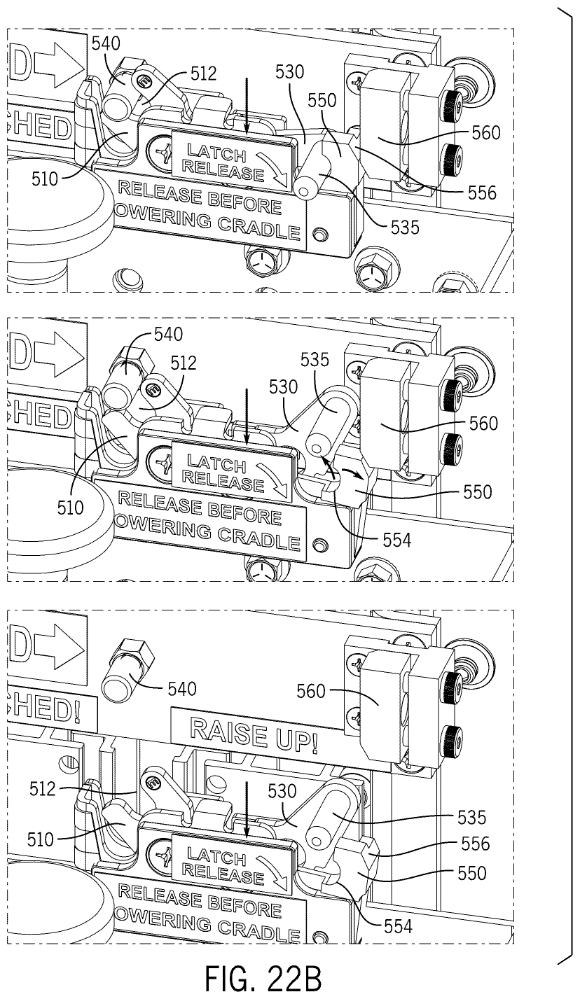

With respect to FIGS. 22-24, a rotary latch 500 is shown, which holds the cradle assembly 300 in its fully raised position. In certain aspects, the cradle assembly 300 will need to be in the fully raised position before the door 35 or cabinet 30 will close. Further, the rotary latch 500 provides additional security in holding the cradle assembly 300 steady during travel.

The rotary latch 500 includes a rotary fork 510 configured to rotate relative a housing 520. The rotary latch 500 further includes a handle 530 with a pin 535 that rotates relative to the housing 520 of the rotary latch 500. The rotary fork 510 is configured to receive a striker 540 in a fork opening 512, while a rotary catch 550 includes a catch opening 554 that is configured to receive the pin 535. The striker 540 is fixed to the frame 100. A pusher portion 560 is fixed to the frame 100 adjacent to a rear wall 552 of the rotary catch 550. The pusher portion 560 is biased toward the rotary catch 550 by a pusher block 570. The pusher portion 560 includes a first chamfered corner 562. The rear wall 552 of the rotary catch 550 further includes a second chamfered corner 556.

FIGS. 22A and 22B show a progression of the rotary latch 500 from a latched position to an unlatched position. In the latched position, the cradle assembly 300 cannot normally move. In the latched position, the striker 540 is in the fork opening 512, and an extension 532 of the handle 530 fits into or against a catch 514 of rotary fork 510. The engagement of the extension 532 into the catch 514 prevents the rotary fork 510 from rotating. In the unlatched position, the rotary latch 500 generally does not prevent the cradle assembly 300 from moving.

In order to lower the cradle assembly 300, the user rotates the handle 530 downward (clockwise in this aspect) and catches the pin 535 in the catch opening 554 of the rotary catch 550. When the handle 530 rotates downward, the extension 532 is rotated out of the catch 514 of the rotary fork 510, which frees the rotary fork 510 to rotate. When a lowering force is applied, the rotary fork 510 begins to rotate (clockwise in this aspect), which begins to free the rotary fork 510 from the striker 540. When the second chamfered corner 556 of the rotary catch 550 aligns or passes the first chamfered corner 562 of the pusher portion 560, the rotary catch 550 is freed such that it can rotate to release the pin 535. Now, the handle 530 rotates upward under bias from the housing 520, and the rotary fork 510 is ready to re-engage the striker 540 when the cradle assembly 300 is raised. The cradle assembly 300 may be continued to be lowered or moved.

The rotary latch 500 resets itself during the lowering process. This provides for automatic latching of the cradle assembly 300 to the rotary latch 500. When the cradle assembly 300 is raised back upward to the striker 540, the fork opening 512 engages the striker 540 causing the rotary fork 510 to rotate counterclockwise, which engages the extension 532 into the catch 514, which holds the rotary fork 510 in the latched position. The user does not need to operate the rotary latch 500 in order to put the cradle assembly 300 in the latched position. The user needs to raise the cradle assembly 300, which causes the rotary latch 500 to engage to the latched position. This provides for automatic latching of the cradle assembly 300 to the rotary latch 500.

The lift system 10 includes multiple crash resistance features and safety features. For example, the lift system 10 may include safety studs 112 and 122 at a bottom of the first vertical member 110 and the second vertical member 120. The safety studs 112 and 122 prevent the 300 from disengaging from the frame 100. For example, the lift system 10 may include a glued frame 100 to retain the counterbalance assembly 200 and the cradle assembly 300 during a crash. For example, gibbs to interlock with the frame 100.

As such, it should be understood that the disclosure is not limited to the particular aspects described herein, but that various changes and modifications may be made without departing from the spirit and scope of this novel concept as defined by the following claims. Further, many other advantages of applicant's disclosure will be apparent to those skilled in the art from the above descriptions and the claims below.

What is claimed is:

1. A lift system for an oxygen bottle, comprising:
a frame;
a counterbalance assembly, the counterbalance assembly is configured to move relative to the frame, the counterbalance assembly comprising a first biasing device and second biasing device;
the first biasing device is configured to selectively connect and disconnect from the frame;
the second biasing device is configured to selectively connect and disconnect from the frame; and
a cradle assembly is configured to support the oxygen bottle, and the cradle assembly is affixed to the counterbalance assembly.

2. The lift system for an oxygen bottle according to claim 1, wherein the lift system is adjustable to lift and lower oxygen bottles of different weight or diameter.

3. The lift system for an oxygen bottle according to claim 1, wherein the lift system is adjustable to lift and lower oxygen bottles of different weight by connecting or disconnecting one or both of the first biasing device and the second biasing device.

4. The lift system for an oxygen bottle according to claim 1, wherein the lift system is adjustable to lift and lower oxygen bottles of different weight by connecting or disconnecting one or both of the first biasing device and the second biasing device, wherein the first biasing device comprises a first carrier, wherein the second biasing device comprises a second carrier, and wherein the first biasing device and the second biasing device are configured to connect and disconnect from the frame by attaching the first carrier and the second carrier to the frame or detaching the first carrier and the second carrier from the frame.

5. The lift system for an oxygen bottle according to claim 1, wherein the frame includes a first vertical member and a second vertical member, and the counterbalance assembly is configured to move up and down between the first vertical member and the second vertical member.

6. The lift system for an oxygen bottle according to claim 1, wherein the frame includes a first vertical member and a second vertical member, the first vertical member and the second vertical member comprise rollers that roll against the counterbalance assembly.

7. The lift system for an oxygen bottle according to claim 1, wherein the counterbalance assembly comprises a first housing and a second housing, wherein the first housing comprises the first biasing device, wherein the second housing comprise the second biasing device, wherein the first housing and the second housing are joined together and move together relative to the frame.

8. The lift system for an oxygen bottle according to claim 1, further comprising a rotary latch that secures the cradle assembly to the frame.

9. The lift system for an oxygen bottle according to claim 8, wherein the rotary latch comprises a housing with a rotary fork, wherein the rotary fork engages and disengages a striker that is affixed to the frame, wherein a handle is configured to release the rotary fork such that the rotary fork rotates to disengage the striker.

10. The lift system for an oxygen bottle according to claim 8, wherein the rotary latch is configured to reset when the cradle assembly is lowered, and the rotary latch is configured to automatically lock when the cradle assembly is raised and contacts the rotary latch.

11. The lift system for an oxygen bottle according to claim 1, wherein a spring-loaded handle is engaged to the cradle assembly, and the handle is biased to lock and hold the cradle assembly when the handle is released.

12. The lift system for an oxygen bottle according to claim 11, wherein the handle is pivotally engaged to the cradle assembly, the handle comprises a gear locking side that engages a gear rack of the frame to lock and hold the cradle assembly with respect to the frame.

13. The lift system for an oxygen bottle according to claim 1, further comprising a first handle and a second handle, the first and second handles are configured to unlock the counterbalance assembly when actuated such that counterbalance assembly is moveable relative to the frame.

14. The lift system for an oxygen bottle according to claim 1, further comprising a first handle and a second handle positioned on opposite sides of the cradle assembly, further comprising a first thumb lip and a second thumb lip positioned on opposite sides of the cradle assembly, wherein the first handle is configured to pivot inward and abut the first thumb lip, and wherein the second handle is configured to pivot inward and abut the second thumb lip.

15. The lift system for an oxygen bottle according to claim 1, further comprising a first handle with a first gear locking side and a second handle with a second gear locking side, the first and second handles are biased to move inward toward the cradle assembly such that the first gear locking side engages a first gear rack of the frame and the second locking side engages a second gear rack of the frame.

16. The lift system for an oxygen bottle according to claim 1, wherein the frame is configured to engage a door of a cabinet of an emergency vehicle or an ambulance.

17. The lift system for an oxygen bottle according to claim 1, wherein the cradle assembly comprises a bracket configured to adjust to oxygen bottles with different diameters, wherein the bracket comprises an upper set of openings and lower set of openings, a moveable upper bottle support, and a moveable lower bottle support, wherein the moveable upper bottle support and the moveable lower bottle support affix to the bracket in different locations by the upper set of openings and the lower set of openings.

18. The lift system for an oxygen bottle according to claim 1, further comprising a first stop assembly, the first stop assembly comprising a bottom piece and a top cover, wherein the first biasing device include a first cable, wherein the first cable is affixed to a first carrier, wherein the first carrier seats between the bottom piece and the top cover, wherein the bottom piece is affixed to the counterbalance assembly.

19. A lift system for an oxygen bottle, comprising:
a frame,
a counterbalance assembly, the counterbalance assembly is configured to move relative to the frame;
a cradle assembly, the cradle assembly is configured to support an oxygen bottle, and the cradle assembly is affixed to the counterbalance assembly; and
wherein the counterbalance assembly comprises a gas spring with a rod that extends and retracts from the gas spring, wherein a first end of a cable is engaged to an end of the rod, wherein a second end of the cable is engaged to a carrier, and the carrier is configured to engage and disengage with an attachment plate, wherein the attachment plate is affixed to the frame.

20. A lift system for an oxygen bottle, comprising:
a frame,
a counterbalance assembly, the counterbalance assembly is configured to move relative to the frame;
a cradle assembly is configured to support an oxygen bottle, and the cradle assembly is affixed to the counterbalance assembly; and
wherein the counterbalance assembly comprises a first gas spring with a first rod that extends and retracts from the first gas spring, wherein a first end of a first cable is engaged to an end of the first rod, wherein a second end of the first cable is engaged to a first carrier, and the first carrier is configured to engage and disengage with an attachment plate, a second gas spring with a second rod that extends and retracts from the second gas spring, wherein a first end of a second cable is engaged to an end of the second rod, wherein a second end of the second cable is engaged to a second carrier, and the second carrier is engaged to the attachment plate, and a third gas spring with a third rod that extends and retracts from the third gas spring, wherein a first end of a third cable is engaged to an end of the third rod, wherein a second end of the third cable is engaged to a third carrier, and the third carrier is configured to engage and disengage with the attachment plate.

21. The lift system for an oxygen bottle according to claim 20, wherein the counterbalance assembly comprises a first housing, a second housing, and a third housing, wherein the first housing comprises the first gas spring, wherein the second housing comprise the second gas spring, wherein the third housing comprise the third gas spring, wherein first housing, the second housing, and the third housing are joined together and move together relative to the frame.

22. The lift system for an oxygen bottle according to claim 21, further comprising a stop assembly that is affixed to the first housing, the first stop assembly is configured to selectively hold the first carrier.

23. The lift system for an oxygen bottle according to claim 22, wherein the first gas spring is active and biases the lift system when the first carrier is engaged to the attachment plate, and wherein the first gas spring is passive and does not bias the lift system when the first stop assembly holds the first carrier.

24. The lift system for an oxygen bottle according to claim 22, further comprising a bottom piece and a top cover, wherein the carrier seats between the bottom piece and the top cover, wherein the bottom piece is affixed to the first housing.
